(19) United States
(12) Patent Application Publication
(10) Pub. No.: US 2020/0181391 A1
(43) Pub. Date: Jun. 11, 2020

(54) HIGH HEAT AND HIGH TOUGHNESS EPOXY COMPOSITIONS, ARTICLES, AND USES THEREOF

(71) Applicant: SABIC GLOBAL TECHNOLOGIES B.V., BERGEN OP ZOOM (NL)

(72) Inventors: Prakash SISTA, Mt. Vernon, IN (US); Devendra BAJAJ, Mt. Vernon, IN (US); Edward Norman PETERS, Selkirk, NY (US)

(21) Appl. No.: 16/333,457

(22) PCT Filed: Sep. 26, 2017
(86) PCT No.: PCT/US2017/053466

§ 371 Date: Mar. 14, 2019

Related U.S. Application Data
(60) Provisional application No. 62/399,875, filed on Sep. 26, 2016.

(51) Int. Cl. C08L 63/00; C08G 59/50; C08G 59/26; C08L 81/06

(52) U.S. Cl. CPC C08L 63/00; C08G 59/5033; C08K 5/1515; C08L 81/06; C08G 59/26

(57) ABSTRACT

A high heat epoxy composition comprising: a high heat epoxy compound; a thermoplastic polymer; and a hardener; wherein a cured sample of the high heat epoxy composition has a glass transition temperature greater than or equal to 200° C., preferably greater than 220° C., or preferably greater than 240° C., measured as per ASTM D3418; or wherein a cured sample of the composition has a fracture toughness greater than 150 J/m², preferably greater than 170 J/m², preferably greater than 190 J/m², measured as per ASTM D5045 is provided.

### CROSS-REFERENCE TO RELATED APPLICATIONS

This application claims priority to U.S. provisional application Ser. No. 62/399,875, filed Sep. 26, 2016, the contents of which are hereby incorporated by reference.

### BACKGROUND

Epoxy polymers are used in a wide variety of applications including protective coatings, adhesives, electronic laminates, flooring and paving applications, glass fiber-reinforced pipes, and automotive parts. In their cured form, epoxy polymers offer desirable properties including good adhesion to other materials, excellent resistance to corrosion and chemicals, high tensile strength, and good electrical resistance. However, cured epoxy polymers can be brittle and lack toughness.

There is a need for epoxy-based materials with improved properties.

### SUMMARY

A high heat epoxy composition comprises: a high heat epoxy compound having formula:

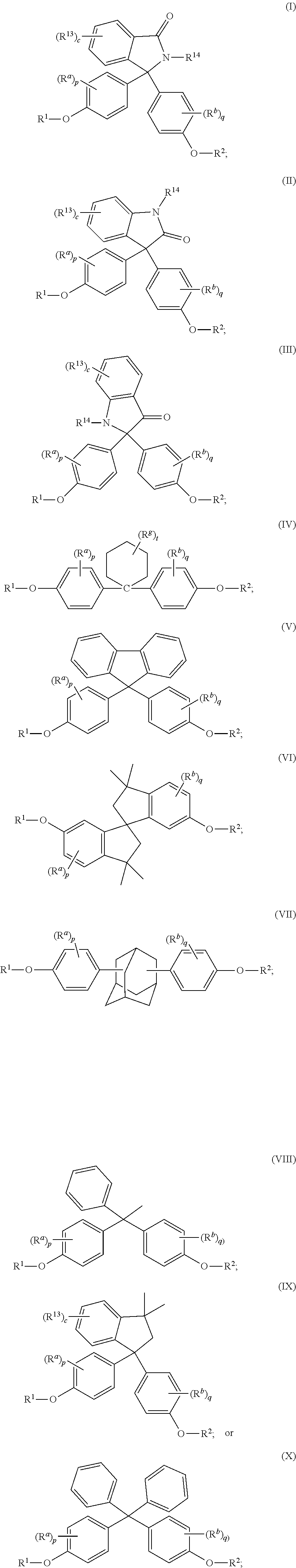

wherein R¹ and R² at each occurrence are each independently an epoxide-containing functional group; Ra and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; and a thermoplastic polymer; and a hardener; wherein a cured sample of the high heat epoxy composition has a glass transition temperature greater than or equal to 200° C., preferably greater than 220° C., or preferably greater than 240° C., measured as per ASTM D3418 is provided.

A high heat epoxy composition comprises: a high heat epoxy compound having formula:

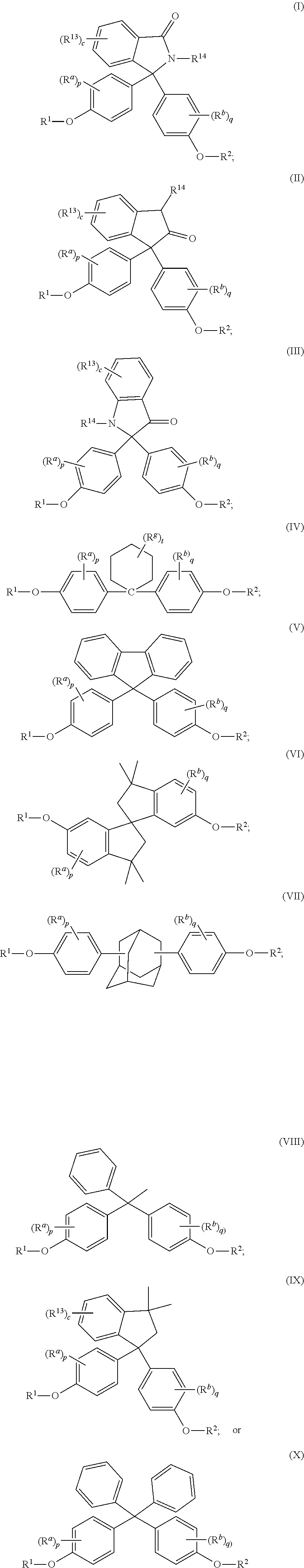

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; and a thermoplastic polymer; and a hardener; wherein a cured sample of the composition has a fracture toughness greater than 150 J/m², preferably greater than 170 J/m², preferably greater than 190 J/m², measured as per ASTM D5045 is provided.

A cured composition comprising the product obtained by curing a provided high heat epoxy composition is provided. An article comprising a cured provided composition is provided.

### DETAILED DESCRIPTION

The inventors hereof have discovered compositions that provide desirable properties. The compositions include a high heat epoxy compound; a thermoplastic polymer; and a hardener. In an embodiment, the hardener is an aromatic diamine compound. In an embodiment, a cured sample of the high heat epoxy composition has a glass transition temperature greater than or equal to 200° C., measured as per ASTM D3418. In an embodiment, a cured sample of the high heat epoxy composition has a glass transition temperature greater than 220° C., measured as per ASTM D3418. In an embodiment, a cured sample of the high heat epoxy composition has a glass transition temperature greater or preferably greater than 240° C., measured as per ASTM D3418. In an embodiment, a cured sample of the high heat epoxy composition has a fracture toughness greater than 150 J/m², measured as per ASTM D5045. In an embodiment, a cured sample of the high heat epoxy composition has a fracture toughness greater than 170 J/m², measured as per ASTM D5045. In an embodiment, a cured sample of the high heat epoxy composition has a fracture toughness greater than 190 J/m², measured as per ASTM D5045.

In embodiments, the high heat epoxy compound has formula (I) to (X):

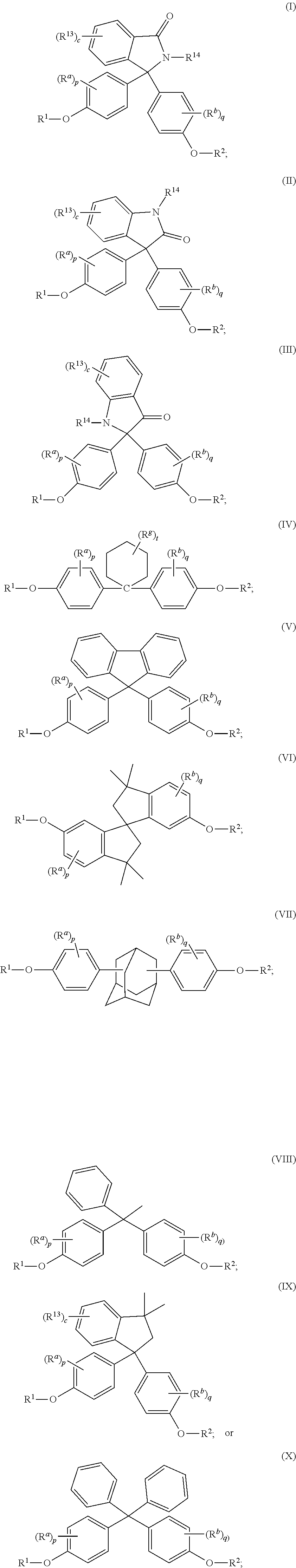

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10.

In embodiments, R¹ and R² at each occurrence can each be independently:

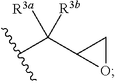

wherein R^{3a}and R^{3b} are each independently hydrogen or C₁-C₁₂ alkyl In certain embodiments, R¹ and R² are each independently

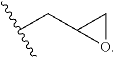 [SMILES: *CC1CO1]

In embodiments, the high heat epoxy compound has the formula

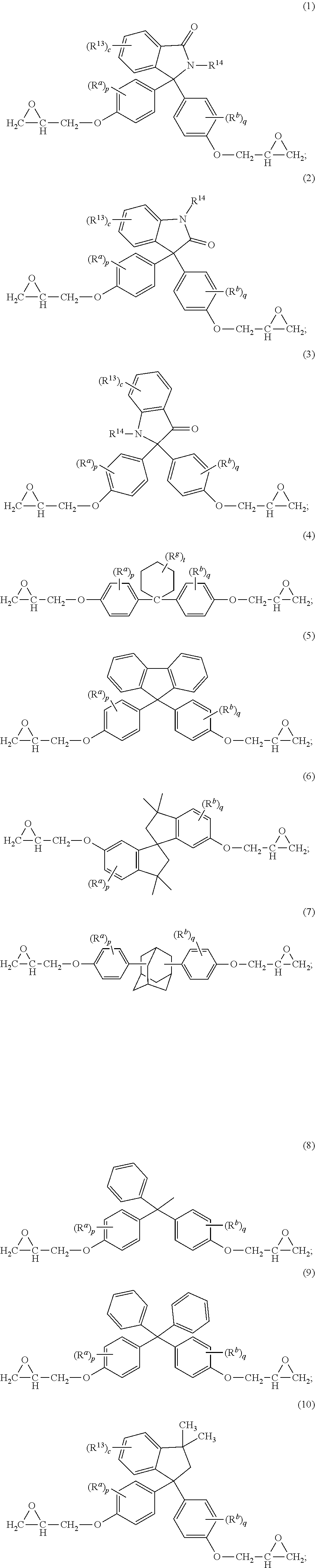

wherein R^{a} and le at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10.

In some embodiments, Ra and R^{b} at each occurrence are each independently halogen, C₁-C₁₂ alkyl, or C₁-C₁₂ alkoxy; p and q at each occurrence are each independently 0 to 2; R¹³ at each occurrence is independently a halogen or a C₁-C₃ alkyl group; c at each occurrence is independently 0 to 2; R¹⁴ at each occurrence is independently a C₁-C₆ alkyl or phenyl; R^{g} at each occurrence is independently C₁-C₁₂ alkyl, or two R^{g} groups together with the carbon atoms to which they are attached form a four-, five, or six-membered cycloalkyl group; and t is 1 to 5.

In some embodiments, Ra and R^{b} at each occurrence are each independently C₁-C₆ alkyl, or C₁-C₆ alkoxy; p and q at each occurrence are each independently 0 to 2; R¹³ at each occurrence is independently a C₁-C₃ alkyl group; c at each occurrence is independently 0 to 2; R¹⁴ at each occurrence is independently a C₁-C₃ alkyl or phenyl; R^{g} at each occurrence is independently C₁-C₆ alkyl; and t is 1 to 5.

In embodiments, the high heat epoxy compound has the formula (1-a), (2-a), or (4-b)

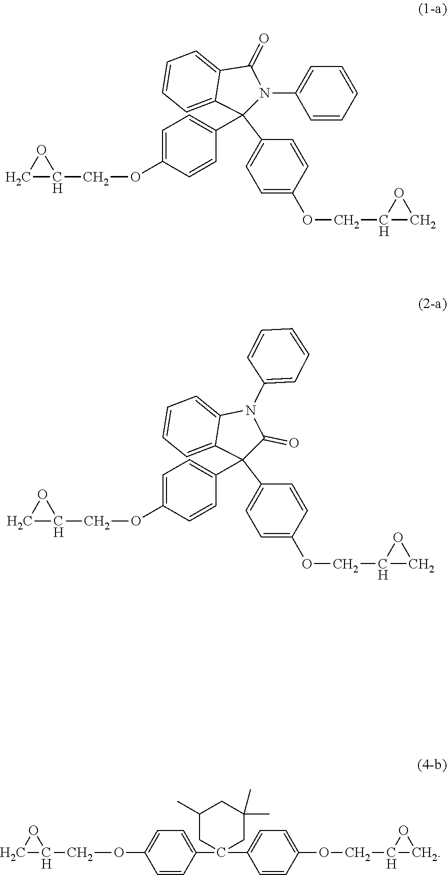 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

In an embodiment, the high heat epoxy compound has the formula (1-a)

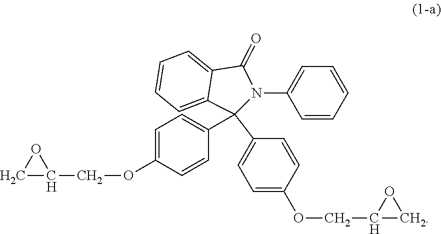 [SMILES: O=C1c2ccccc2C(c2ccc(OCC3CO3)cc2)(c2ccc(OCC3CO3)cc2)N1c1ccccc1]

The high heat epoxy compound can be prepared by methods described in, for example, WO2016/014536. The high heat epoxy compound can be from a corresponding bisphenol compound, e.g., a bisphenol of formula (1′) to (9′).

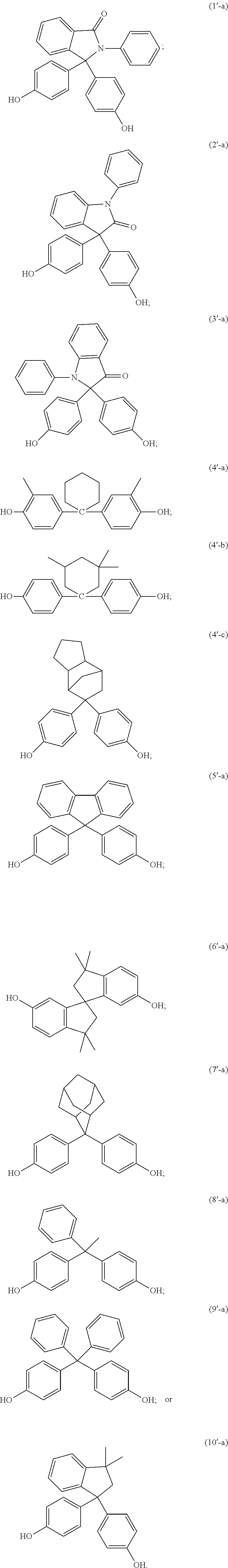

The bisphenol can be provided in a mixture with an epoxide source, such as epichlorohydrin. The resultant mixture can be treated with a catalytic amount of base at a selected temperature. Suitable bases include, but are not limited to, carbonates (e.g., sodium bicarbonate, ammonium carbonate, or dissolved carbon dioxide), and hydroxide bases (e.g., sodium hydroxide, potassium hydroxide, or ammonium hydroxide). The base can be added as a powder (e.g., powdered sodium hydroxide). The base can be added slowly (e.g., over a time period of 60 to 90 minutes). The temperature of the reaction mixture can be maintained at 20° C. to 24° C., for example. The reaction can be stirred for a selected time period (e.g., 5 hours to 24 hours, or 8 hours to 12 hours). The reaction can be quenched by addition of an aqueous solvent, optionally along with one or more organic solvents (e.g., ethyl acetate). The aqueous layer can be extracted (e.g., with ethyl acetate), and the organic extract can be dried and concentrated. The crude product can be purified (e.g., by silica gel chromatography) and isolated. The isolated product can be obtained in a yield of 80% or greater, 85% or greater, or 90% or greater.

In certain embodiments, the composition can comprise a high heat epoxy compound wherein the purity is 95% or greater, preferably 97% or greater, preferably 99% or greater, as determined by high performance liquid chromatography (HPLC). WO 2016/014536A1 and US Publication 2015/041338 disclose that high purity epoxy with low oligomer content exhibits lower viscosity, which can facilitates fiber wet out during processing to make prepgregs and laminates.

The high heat epoxy compound can have a metal impurity content of 3 ppm or less, 2 ppm or less, 1ppm or less, 500 ppb or less, 400 ppb or less, 300 ppb or less, 200 ppb or less, or 100 ppb or less. The metal impurities may be iron, calcium, zinc, aluminum, or a combination thereof. The compounds can have an unknown impurities content of 0.1 wt % or less. The compounds can have a color APHA value of 40 or less, 35 or less, 30 or less, 25 or less, 20 or less, 19 or less, 18 or less, 17 or less, 16 or less, or 15 or less, as measured using test method ASTM D1209.

The high heat epoxy compounds can be substantially free of epoxide oligomer impurities. The epoxides can have an oligomer impurity content of less than or equal to 3%, less than or equal to 2%, less than or equal to 1%, less than or equal to 0.5%, less than or equal to 0.4%, less than or equal to 0.3%, less than or equal to 0.2%, or less than or equal to 0.1%, as determined by high performance liquid chromatography. The epoxides can have an epoxy equivalent weight corresponding to purity of the bisepoxide of 95% purity or greater, 96% purity or greater, 97% purity or greater, 98% purity or greater, 99% purity or greater, or 100% purity. Epoxy equivalent weight (EEW) is the weight of material in grams that contains one mole of epoxy groups. It is also the molecular weight of the compound divided by the number of epoxy groups in one molecule of the compound.

The high heat epoxy composition includes a thermoplastic polymer. In embodiments, the thermoplastic polymer comprises a polyetherimide (PEI), polyethersulfone (PES), polyphenylsulfone (PPSU), polysulfone, polyarylsulfone, polyaryl ether, polyphenylene ether, polyetheretherketone (PEEK), polyetherketone (PEK), polyetherketoneketone (PEKK), polyketone sulfide (PKS), polyaryletherketone (PAEK), aromatic polyamide (PA), polyamideimide (PAI), polysiloxane, polyimide siloxane, polyimide (PI), or a combination comprising at least one of the foregoing. In an embodiment, the thermoplastic polymer does not include reactive end groups. In an embodiment, the thermoplastic polymer includes one or more reactive end groups. Examples of reactive end groups include amine, hydroxyl, or carboxyl groups. Specific examples of reactive thermoplastic polymers include amine terminated polyetherimide; hydroxyl terminated polyethersulfone; or hydroxyl terminated polyphenylene ether.

In an embodiment, the high heat epoxy composition comprises up to 25 wt % of the thermoplastic polymer. In an embodiment, the high heat epoxy composition comprises up to 3 to 15 wt % of the thermoplastic polymer. In an embodiment, the high heat epoxy composition comprises 3 to 10 wt % of the thermoplastic polymer.

The high heat epoxy composition can include a curing promoter. The term “curing promoter” as used herein encompasses compounds whose roles in curing epoxy compounds are variously described as those of a hardener, a hardening accelerator, a curing catalyst, and a curing co-catalyst, among others. The curing promoter can be a hardener. The hardener can be an amine-containing compound. The hardener can be an aromatic diamine compound.

In an embodiment, the high heat epoxy composition includes an aromatic diamine compound. In embodiments, the amine-containing compound can be 4-aminophenyl sulfone (DDS), 4,4′-methylenedianiline, diethyltoluenediamine, 4,4′-methylenebis(2,6-diethyl aniline), m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine, p-xylylenediamine, a diethyl toluene diamine, or a combination comprising at least one of the foregoing. In embodiments, the amine-containing compound can be 4-aminophenyl sulfone (DDS), 4,4′-methylenebis-(2,6-diethyl aniline) (MDEA), or a combination comprising at least one of the foregoing. In an embodiment, the hardener is methyl-5-norbornene-2,3-dicarboxylic anhydride (NMA). The amount of curing promoter will depend on the type of curing promoter, as well as the identities and amounts of the other components of the high heat epoxy composition. For example, when the curing promoter is an aromatic diamine compound, it can be used in an amount of 15 to 50 weight percent of the high heat epoxy composition. In an embodiment, the high heat epoxy composition comprises 15 to 25 wt % of an aromatic diamine compound.

In an embodiment, a cured sample of the high heat epoxy composition has a glass transition temperature of 200 to 270° C., as measured as per ASTM D3418. In an embodiment, a cured sample of the high heat epoxy composition has a glass transition temperature of 220 to 270° C., as measured as per ASTM D3418. In an embodiment, a cured sample of the high heat epoxy composition has a glass transition temperature of 250 to 270° C., as measured as per ASTM D3418.

In an embodiment, the high heat epoxy composition comprises 50 to 95 wt %, preferably 60 to 90 wt %, preferably 65 to 85 wt % of a high heat epoxy compound having formula (1-a)

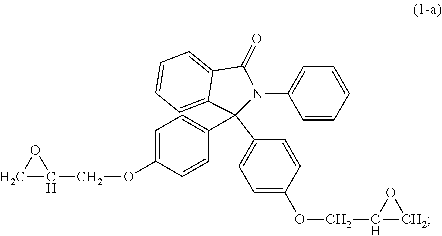 [SMILES: O=C1c2ccccc2C(c2ccc(OCC3CO3)cc2)(c2ccc(OCC3CO3)cc2)N1c1ccccc1]

and 1 to 20 wt % of a polyethersulfone or a polyetherimide. In an embodiment, the high heat epoxy composition comprises 60 to 90 wt % of a high heat epoxy compound having formula (1-a) and 1 to 20 wt % of a polyethersulfone or a polyetherimide. In an embodiment, the high heat epoxy composition comprises 65 to 85 wt % of a high heat epoxy compound having formula (1-a) and 1 to 20 wt% of a polyethersulfone or a polyetherimide. In an embodiment, the thermoplastic polymer is a polyetherimide.

In an embodiment, the high heat epoxy composition does not contain a solvent. The high heat epoxy compositions can include a solvent to prepare homogeneous epoxy blends and then the solvent can be removed. In an embodiment, 10 to 40 wt % of a solvent can be used to prepare the high heat epoxy composition. In an embodiment, the solvent comprises dioxane, methylene chloride, chloroform, or a combination comprising at least one of the foregoing.

The high heat epoxy composition can be cured, using typical conditions, including those described below.

Applications for the high heat epoxy compositions include, for example, acid bath containers; neutralization tanks; aircraft components; bridge beams; bridge deckings; electrolytic cells; exhaust stacks; scrubbers; sporting equipment; stair cases; walkways; automobile exterior panels such as hoods and trunk lids; floor pans; air scoops; pipes and ducts, including heater ducts; industrial fans, fan housings, and blowers; industrial mixers; boat hulls and decks; marine terminal fenders; tiles and coatings; building panels; business machine housings; trays, including cable trays; concrete modifiers; dishwasher and refrigerator parts; electrical encapsulants; electrical panels; tanks, including electrorefining tanks, water softener tanks, fuel tanks, and various filament-wound tanks and tank linings; furniture; garage doors; gratings; protective body gear; luggage; outdoor motor vehicles; pressure tanks; printed circuit boards; optical waveguides; radomes; railings; railroad parts such as tank cars; hopper car covers; car doors; truck bed liners; satellite dishes; signs; solar energy panels; telephone switchgear housings; tractor parts; transformer covers; truck parts such as fenders, hoods, bodies, cabs, and beds; insulation for rotating machines including ground insulation, turn insulation, and phase separation insulation; commutators; core insulation and cords and lacing tape; drive shaft couplings; propeller blades; missile components; rocket motor cases; wing sections; sucker rods; fuselage sections; wing skins and flairings; engine narcelles; cargo doors; tennis racquets; golf club shafts; fishing rods; skis and ski poles; bicycle parts; transverse leaf springs; pumps, such as automotive smog pumps; electrical components, embedding, and tooling, such as electrical cable joints; wire windings and densely packed multi-element assemblies; sealing of electromechanical devices; battery cases; resistors; fuses and thermal cut-off devices; coatings for printed wiring boards; casting items such as capacitors, transformers, crankcase heaters; small molded electronic parts including coils, capacitors, resistors, and semiconductors; as a replacement for steel in chemical processing, pulp and paper, power generation, and wastewater treatment; scrubbing towers; pultruded parts for structural applications, including structural members, gratings, and safety rails; swimming pools, swimming pool slides, hot-tubs, and saunas; drive shafts for under the hood applications; dry toners for copying machines; marine tooling and composites; heat shields; submarine hulls; prototype generation; development of experimental models; laminated trim; drilling fixtures; bonding jigs; inspection fixtures; industrial metal forming dies; aircraft stretch block and hammer forms; vacuum molding tools; flooring, including flooring for production and assembly areas, clean rooms, machine shops, control rooms, laboratories, parking garages, freezers, coolers, and outdoor loading docks; electrically conductive compositions for antistatic applications; for decorative flooring; expansion joints for bridges; injectable mortars for patch and repair of cracks in structural concrete; grouting for tile; machinery rails; metal dowels; bolts and posts; repair of oil and fuel storage tanks, and numerous other applications.

The compositions and methods described herein are further illustrated by the following non-limiting examples.

### EXAMPLES

The following components were used in the examples. Unless specifically indicated otherwise, the amount of each component is in weight percent in the following examples, based on the total weight of the composition.

TABLE 1

| Component | Description | Source |
|---|---|---|
| TGDDM | Tetraglycidyldiaminodiphenylmethane, CAS Reg. No. 28768-32-3; with | Sigma-Aldrich |
| | an epoxy equivalent weight of 109-117 grams/equivalent; obtained as | |
| | 4,4′-Methylenebis(N,N-diglycidylaniline) | |
| PPPBP-epoxy | 1,1-bis(4-epoxyphenyl)-N-phenylphthalimidine, with an epoxy | SABIC |
| | equivalent weight 252.5 grams/equivalent, CAS Registry No. 22749-87-7 | |
| DDS | 4,4′-Diaminodiphenyl sulfone, CAS Reg. No. 80-08-0 | |
| PEI | Polymer of bisphenol-A dianhydride and m-phenylene diamine, Mw | SABIC |
| | about 44,000; CAS Reg. No. 61128-46-9 (ULTEM 1010) | |
| PEI-2 | Polymer of bisphenol-A dianhydride and diamine diphenyl sulfone, | |
| | Mw about 38,000; CAS Reg. No. 77699-82-2 (EXTEM XH6050) | |
| PEI-3 | Polymer of bisphenol-A dianhydride, m-phenylene diamine and about | |
| | 20 wt % bis(3-amino propyl) polydimethyl siloxane, Mw about 39,000 | |
| | CAS Reg. No. 99904-16-2 (SILTEM STM1700) | |
| PEI-4 | Amine terminated poly(etherimide) made via reaction of bisphenol-A- | |
| | dianhydride with molar excess of m-phenylene diamine, Mw about | |
| | 15,000 g/mol (determined via GPC using polystyrene standards) | |
| PES | Polyethersulfone, average molecular weight = 46500 g/mol determined | Solvay |
| | by GPC using polystyrene standard. VIRANTAGE VW10200RP | Specialty |
| | | Polymers |
| SA90 | Copolymer of 2,2-bis(3,5-dimethyl-4-hydroxyl)propane and 2,6- | |
| | dimethylphenol. CAS Reg. No. 1012321-47-9, the copolymer having an | |
| | average of about 2 hydroxyl groups per molecule, a hydroxyl equivalent | |
| | weight of about 872 grams/equivalent, a glass transition temperature of | |
| | about 150° C. and an intrinsic viscosity of about 0.09 deciliter per gram | |
| | measured by Ubbelohde viscometer at 25° C. in chloroform; obtained as | |
| | PPO SA90 Resin from SABIC. | |
| Mold Max | Silicone rubber formulation obtained as Mold Max 40 (Part A and Part B) | Smooth-on Inc. |
| Methylene | Dichloromethane, CAS Reg. No. 75-09-2 | Fisher Scientific |
| Chloride | | |
| Dioxane | 1,4-dioxane, CAS Reg. No. 123-91-1 | Fisher Scientific |
| MAC-971 | Mold release agent | |

Compositions were tested using the test methods listed in Table 2. Unless indicated otherwise, all test methods are the test methods in effect as of the filing date of this application.

TABLE 2

| Property | Units | Description (Conditions) | Test |
|---|---|---|---|
| Glass transition | ° C. | TA Instruments Q1000 DSC. Sample size was typically 10 to 20 | ASTM D3418 |
| temperature (T_{g}) | | milligrams. Scan range from 40 to 325° C. under a nitrogen | |
| | | atmosphere with a heating rate of 20° C./min. Temperature held at | |
| | | 325° C. for 1 min, cooled back to 40° C. (20° C./min), then | |
| | | held at 40° C. for 1 min, and the heating cycle was repeated. | |
| | | The second heating cycle was usually used to obtain the Tg. | |
| Fracture | J/m² | 23° C. Displacement control at 1 mm/min. | ASTM D5045 |
| toughness, GIC | | | |

Results are provided for compositions of PPPBP-epoxy in the presence of the hardening agent 4,4′-diaminodiphenyl sulfone (DDS) and cured under a set temperature protocol to obtain castings. The compact tension (CT) specimen castings were tested under mode I loading to determine the fracture toughness results. Castings were also prepared with thermoplastic polymers, including polyetherimide (PEI) and polyethersulfone (PES), to determine the effect on the fracture toughness of the PPPBP-epoxy. Comparative results were obtained using 4,4′-methylenebis(N,N-diglycidylaniline) (TGDDM). The fracture toughness and thermal analysis data of PPPBP-epoxy castings were compared to the TGDDM castings.

### General Procedure for the Preparation of Silicone Molds

An aluminum block was machined to prepare a cavity that holds four positive compact tension (CT) specimens. This mold was used to prepare a negative silicone mold that was used to prepare CT specimens.

For preparing silicone molds, the aluminum mold was dried (heated to 115° C. overnight and cooled) and mold release (MAC-971) was applied to it and allowed to dry in inert atmosphere. Part A and Part B of Moldmax 40 (ten parts of part A, one part of part B) were mixed to prepare a uniform solution. The solution was degassed in a vacuum oven at room temperature for about 15 mins, and poured into the aluminum mold. The mold was allowed to cure at room temperature for 16-18 hours. Thereafter, the cured silicone mold was removed from the aluminum mold and placed in a convection oven for 16-18 hours to remove all traces of moisture and solvent.

Samples of TGDDM with DDS and PPPBP-epoxy with DDS were prepared, either with or without thermoplastic polymers. In general, the thermoplastic polymer was dissolved in hot epoxy to form a homogeneous solution. Phase-separated morphologies can be obtained by temperature induced phase separation by decreasing the temperature or reaction induced phase separation during curing. Although Applicant is not required to provide a theory of operation, the phase separation is believed to provide improvements in toughness of the cured part.

### Preparation of TGDDM Castings with No Thermoplastic Polymer

TGDDM was heated to 140° C. in a reaction kettle and 30 parts per hundred (phr) of DDS was allowed to dissolve in the warm polymer by stirring. The warm, homogeneous epoxy/DDS solution was degassed under vacuum and then poured into a silicone mold which was preheated to 140° C. The filled mold was placed in an oven at 140° C. and the cure temperature was programmed up to 220° C.

### Preparation of TGDDM Castings with Thermoplastic Polymer

TGDDM and the thermoplastic polymer were mixed in the stated ratio and heated to 140° C. in a reaction kettle until a homogeneous solution was obtained. 30 phr of DDS was allowed to dissolve in the warm polymer blend by stirring. The warm, homogeneous epoxy/DDS solution was degassed under vacuum and then poured into a silicone mold which was preheated to 140° C. The filled mold was placed in an oven at 140° C. and the cure temperature was programmed up to 220° C.

### Preparation of PPPBP-Epoxy Castings with No Thermoplastic Additives

### Method 1: Solvent Processing PPPBP-Epoxy

PPPBP-epoxy was heated to 90° C. in a reaction kettle in the presence of about 40 wt % of dioxane. After complete dissolution of the polymer, about 50% of the solvent was removed by applying vacuum. The reaction was heated to 140° C. and 30 phr of DDS was added to the flask and allowed to dissolve in the warm epoxy solution by stirring. The warm, homogeneous epoxy/DDS solution was degassed under vacuum to remove all traces of solvent and then poured into a silicone mold which was preheated to 140° C. The filled mold was placed in an oven at 140° C. and the cure temperature was programmed up to 220° C.

### Method 2: Melt Processing PPPBP-Epoxy

PPPBP-epoxy was heated to 165° C. in a reaction kettle till it melts completely. After a homogeneous solution is obtained, the reaction was cooled down to 140° C. and 30 phr of DDS was added to the flask and allowed to dissolve in the warm epoxy solution by stirring. The warm, homogeneous epoxy/DDS solution was degassed under vacuum and then poured into a silicone mold which was preheated to 140° C. The filled mold was placed in an oven at 140° C. and the cure temperature was programmed up to 220° C.

### Preparation of PPPBP-Epoxy Castings with Non-Reactive Thermoplastic Polymer

### Method 3: Solvent Processing PPPBP-Epoxy

PPPBP-epoxy and the thermoplastic polymer were mixed in the desired ratio, and were heated to 90° C. in the presence of about 30 wt % of dioxane and about 20 wt % of methylene chloride. After complete dissolution of the epoxy and the thermoplastic, about half of the solvent was removed by applying vacuum. The reaction was heated to 140° C. and 30 phr of DDS was added to the flask and allowed to dissolve in the warm epoxy solution by stirring. The warm, homogeneous epoxy/DDS solution was degassed under vacuum to remove all traces of solvent and then poured into a silicone mold which was preheated to 140° C. The filled mold was placed in an oven at 140° C. and the cure temperature was programmed up to 220° C.

### Method 4: Melt Processing PPPBP-Epoxy

PPPBP-epoxy was heated to 165° C. in a reaction kettle till it melts completely. After a homogeneous solution is obtained, the reaction was cooled down to 140° C. and the desired amount of thermoplastic polymer was added to the flask. The reaction was stirred till all the polymer dissolved in the epoxy and a homogeneous solution was obtained. 30 phr of DDS was added to the flask and allowed to dissolve in the warm epoxy solution by stirring. The warm, homogeneous epoxy/DDS solution was degassed under vacuum and then poured into a silicone mold which was preheated to 140° C. The filled mold was placed in an oven at 140° C. and the cure temperature was programmed up to 220° C.

### Preparation of PPPBP-Epoxy Castings with Reactive Thermoplastic Polymer

### Method 5: Solvent Processing PPPBP-Epoxy

PPPBP-epoxy and the thermoplastic polymer were mixed in the desired ratio, and were heated to 90° C. in the presence of about 30 wt % of dioxane and about 20 wt % of methylene chloride. After complete dissolution of the epoxy and the thermoplastic, about half of the solvent was removed by applying vacuum. The reaction was heated to 140° C. and 30 phr of DDS was added to the flask and allowed to dissolve in the warm epoxy solution by stirring. The warm, homogeneous epoxy/DDS solution was degassed under vacuum to remove all traces of solvent and then poured into a silicone mold which was preheated to 140° C. The filled mold was placed in an oven at 140° C. and the cure temperature was programmed up to 220° C.

### Method 6: Melt Processing PPPBP-Epoxy

PPPBP-epoxy was heated to 165° C. in a reaction kettle till it melts completely. After a homogeneous solution is obtained, the reaction was cooled down to 140° C. and the desired amount of thermoplastic polymer was added to the flask. The reaction was stirred till all the polymer reacted with the epoxy and a homogeneous solution was obtained. 30 phr of DDS was added to the flask and allowed to dissolve in the warm epoxy solution by stirring. The warm, homogeneous epoxy/DDS solution was degassed under vacuum and then poured into a silicone mold which was preheated to 140° C. The filled mold was placed in an oven at 140° C. and the cure temperature was programmed up to 220° C.

### Curing Protocol

After pouring the polymer into a preheated mold at 140° C., the mold was placed in an oven at 140° C. After 60 minutes the temperature was increased to 160° C. After 60 minutes the temperature was increased to 180° C. After 60 minutes the temperature was increased to 200° C. After 30 minutes the temperature was increased to 220° C. After 30 minutes the oven was turned off. After cooling to ambient temperatures, the casting was removed from the mold and tested.

### Pre-Cracking and Fracture Toughness Testing

The CT castings were milled to achieve a flat, uniform surface. All CT specimen castings were dry polished with 600 grit sand paper to a final thickness of 8 mm.

A sharp pre-crack was initiated from the notch tip using a razor tap method. In this method, a small impact force was applied to a sharp razor blade that was resting on a test sample to start a sharp pre-crack.

After precracking, specimens were mounted on special tension test clevis and tested under opening mode I load, applied with a universal test machine (Zwick Z2.5). Loads were applied under displacement control at 1 mm/min. Post-test, fractured surfaces of all specimens were imaged under a light microscope to measure the crack length created by the tapping method according to ASTM D5045.

Critical strain energy release rate (GIC) was determined directly from the energy derived from integration of the load versus displacement curve up to the maximum load to failure, according to ASTM D5045.

Results are provided in Tables 3 and 4. PPPBP-epoxy polymer without any thermoplastic polymer exhibited a toughness of 170 J/m², which was two times higher than TGDDM epoxy polymer (103 J/m²) without thermoplastic polymer. Addition of thermoplastic polymers PES and PEI provides improvement in the fracture toughness in both PPPBP and TGDDM epoxy polymer. Fracture toughness of PPPBP-epoxy polymer increased by approximately 56% and 63% by addition of 10.3% weight of PES and PEI, respectively.

TABLE 3
Properties of epoxy castings with non-reactive polymer

| | | | | Thermoplastic | | | |
|---|---|---|---|---|---|---|---|
| | Epoxy | Epoxy | Thermoplastic | polymer added | DDS | T_{g} of matrix | GIC |
| Examples | Matrix | (wt %) | polymer | (wt %) | (wt %) | (° C.) | (J/m²) |
| Comparative | TGDDM | 76.92 | None | 0 | 23.08 | 259.5 | 103 |
| Example 1A | | | | | | | |
| Comparative | | 74.07 | PEI | 3.70 | 22.22 | 250.4 | 136 |
| Example 1B | | | | | | | |
| Comparative | | 71.43 | PEI | 7.14 | 21.43 | 249.9 | 170 |
| Example 1C | | | | | | | |
| Comparative | | 68.97 | PEI | 10.34 | 20.69 | 247.9 | 189 |
| Example 1D | | | | | | | |
| Comparative | | 74.07 | PEI-2 | 3.70 | 22.22 | 235.4 | 118 |
| Example 3A | | | | | | | |
| Comparative | | 71.43 | PEI-2 | 7.14 | 21.43 | 236.0 | 173 |
| Example 3B | | | | | | | |
| Comparative | | 68.97 | PEI-2 | 10.34 | 20.69 | 240.8 | 156 |
| Example 3C | | | | | | | |
| Comparative | | 74.07 | PEI-3 | 3.70 | 22.22 | 236.3 | 200 |
| Example 3D | | | | | | | |
| Comparative | | 71.43 | PEI-3 | 7.14 | 21.43 | 235.5 | 326 |
| Example 3E | | | | | | | |
| Example 2A | PPPBP- | 76.92 | None | 0 | 23.08 | 252.8 | 170 |
| Example 2B | epoxy | 74.07 | PEI | 3.70 | 22.22 | 255.0 | 183 |
| Example 2C | | 71.43 | PEI | 7.14 | 21.43 | 253.0 | 314 |
| Example 2D | | 68.97 | PEI | 10.34 | 20.69 | 241.8 | 444 |
| Example 4A | | 74.07 | PEI-2 | 3.70 | 22.22 | 242.4 | 284 |
| Example 4B | | 71.43 | PEI-3 | 7.14 | 21.43 | 265.5 | 276 |

TABLE 4
Properties of epoxy castings with reactive polymer

| | | | | Thermoplastic | | T_{g} of | |
|---|---|---|---|---|---|---|---|
| | Epoxy | Epoxy | Thermoplastic | polymer added | DDS | matrix | GIC |
| Examples | Matrix | (wt %) | polymer | (wt %) | (wt %) | (° C.) | (J/m²) |
| Comparative | TGDDM | 76.92 | None | 0 | 23.08 | 259.5 | 103 |
| Example 1A | | | | | | | |
| Comparative | | 74.07 | PES | 3.70 | 22.22 | 243.3 | 138 |
| Example 1E | | | | | | | |
| Comparative | | 71.43 | PES | 7.14 | 21.43 | 240.3 | 112 |
| Example 1F | | | | | | | |
| Comparative | | 68.97 | PES | 10.34 | 20.69 | 232.2 | 105 |
| Example 1G | | | | | | | |
| Comparative | | 68.97 | PEI-4 | 10.34 | 20.69 | 235.6 | 263 |
| Example 3F | | | | | | | |
| Comparative | | 71.43 | SA90 | 7.14 | 21.43 | 228.9 | 82 |
| Example 3G | | | | | | | |
| Example 2A | PPPBP- | 76.92 | None | 0 | 23.08 | 252.8 | 170 |
| Example 2E | epoxy | 74.07 | PES | 3.70 | 22.22 | | 183 |
| Example 2F | | 71.43 | PES | 7.14 | 21.43 | 255.4 | 267 |
| Example 2G | | 68.97 | PES | 10.34 | 20.69 | 247.1 | 300 |
| Example 4C | | 74.07 | PEI-4 | 3.70 | 22.22 | 257.4 | 274 |
| Example 4D | | 71.43 | PEI-4 | 7.14 | 21.43 | 263.2 | 227 |
| Example 4E | | 68.97 | PEI-4 | 10.34 | 20.69 | 257.6 | 237 |
| Example 4F | | 71.43 | SA90 | 7.14 | 21.43 | 268.5 | 171 |

The compositions, methods, articles and other aspects are further described by the Embodiments below.

Embodiment 1: A high heat epoxy composition comprising: a high heat epoxy compound having formula:

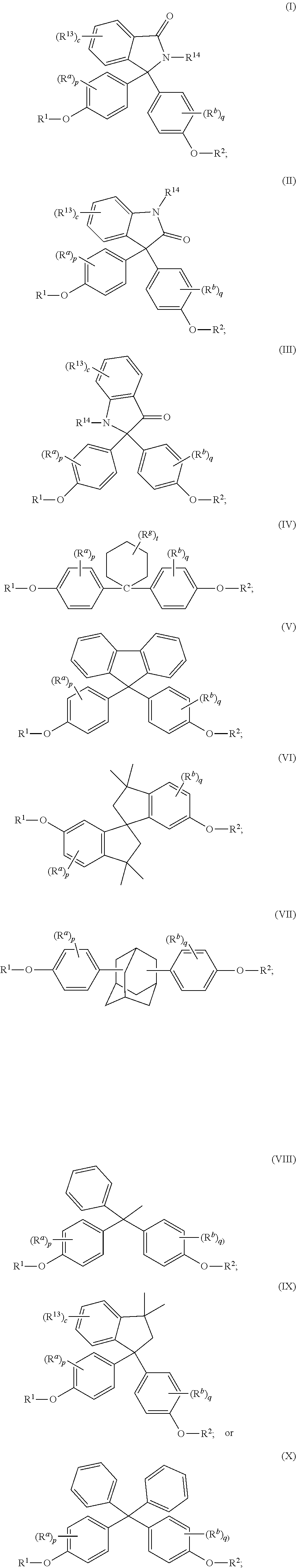

wherein

R¹ and R² at each occurrence are each independently an epoxide-containing functional group;

R^{a} and R^{b} at each occurrence are each independently halogen, C₁-C₁₂ alkyl, C₂-C₁₂ alkenyl, C₃-C₈ cycloalkyl, or C₁-C₁₂ alkoxy;

p and q at each occurrence are each independently 0 to 4; R¹³ at each occurrence is independently a halogen or a C₁-C₆ alkyl group;

c at each occurrence is independently 0 to 4; R¹⁴ at each occurrence is independently a C₁-C₆ alkyl, phenyl, or phenyl substituted with up to five halogens or C₁-C₆ alkyl groups;

R^{g} at each occurrence is independently C₁-C₁₂ alkyl or halogen, or two R^{g} groups together with the carbon atoms to which they are attached form a four-, five, or six-membered cycloalkyl group; and

t is 0 to 10; and a thermoplastic polymer; and a hardener;

wherein a cured sample of the high heat epoxy composition has a glass transition temperature greater than or equal to 200° C., preferably greater than 220° C., or preferably greater than 240° C., measured as per ASTM D3418.

Embodiment 2: The composition of Embodiment 1, wherein a cured sample of the composition has a fracture toughness greater than 150 J/m², preferably greater than 170 J/m², preferably greater than 190 J/m², measured as per ASTM D5045.

Embodiment 3: The composition of Embodiment 1, wherein the thermoplastic polymer comprises a polyetherimide (PEI), amine terminated polyetherimide, polyethersulfone (PES), polyphenyl sulfone (PPSU), polysulfone, polyarylsulfone, polyaryl ether, polyphenylene ether, polyetheretherketone (PEEK), polyetherketone (PEK), polyetherketoneketone (PEKK), polyketone sulfide (PKS), polyaryletherketone (PAEK), aromatic polyamide (PA), polyamideimide (PAI), polysiloxane, polyimide siloxane, polyimide (PI), or a combination comprising at least one of the foregoing.

Embodiment 4: The composition of any one or more of the Embodiments 1 to 3, wherein the composition comprises up to 25 wt %, preferably 3 to 15 wt %, preferably 3 to 10 wt % of the thermoplastic polymer.

Embodiment 5: The composition of any one or more of Embodiments 1 to 4, wherein the hardener is an aromatic diamine compound, preferably wherein the aromatic diamine compound comprises 4-aminophenyl sulfone (DDS), 3-aminophenyl sulfone, 4,4′-methylenedianiline, diethyltoluenediamine, 4,4′-methylenebis (2,6-diethyl aniline), m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine, p-xylylenediamine, diethyl toluene diamines, or a combination comprising at least one of the foregoing.

Embodiment 6: The composition of any one or more of the Embodiments 1 to 5, wherein a cured sample of the composition has a glass transition temperature of 200 to 270° C., preferably 220 to 270° C., preferably 250 to 270° C., as measured as per ASTM D3418.

Embodiment 7: The composition of any one or more of Embodiments 1 to 6, wherein R¹ and R² at each occurrence are each independently

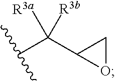

wherein R^{3a} and R^{3b} are ach independently hydrogen or C₁-C₁₂ alkyl.

Embodiment 8: The composition of any one or more of Embodiments 1 to 6, wherein the high heat epoxy compound has the formula (1-a), (2-a), or (4-b)

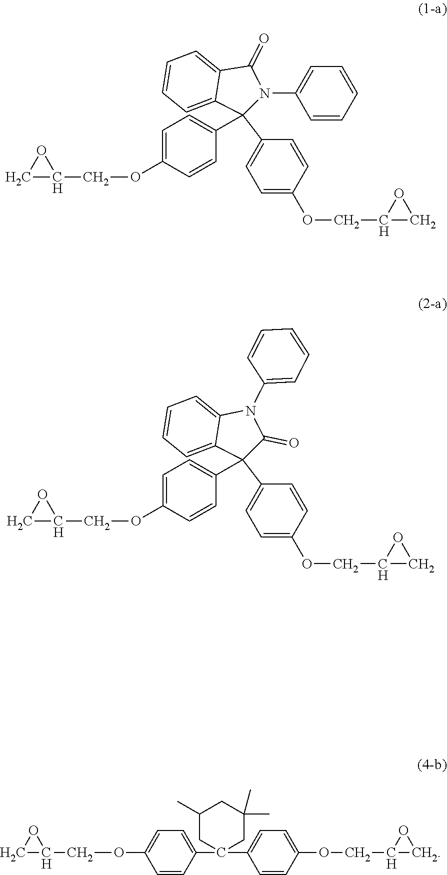 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

Embodiment 9: The composition of any one or more of Embodiments 1 to 8, wherein 10 to 40 wt % of a solvent was used to prepare the high heat epoxy composition.

Embodiment 10: The composition of Embodiment 9, wherein the solvent comprises dioxane, methylene chloride, chloroform, or a combination comprising at least one of the foregoing.

Embodiment 11: The composition of any one or more of Embodiments 1 to 10, wherein a cured sample of the high heat epoxy composition has fracture toughness 10% greater, preferably 25% greater, preferably 50% greater than the fracture toughness of a cured sample of the high heat epoxy composition with 0 wt % of the thermoplastic polymer, wherein the fracture toughness is measured as per ASTM D5045.

Embodiment 12: The composition of any one more of Embodiments 1 to 11, comprising 50 to 95 wt %, preferably 60 to 90 wt %, preferably 65 to 85 wt% of a high heat epoxy compound having formula (1-a)

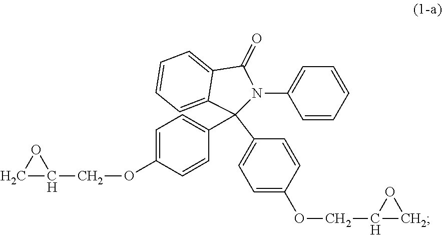 [SMILES: O=C1c2ccccc2C(c2ccc(OCC3CO3)cc2)(c2ccc(OCC3CO3)cc2)N1c1ccccc1]

and 1 to 20 wt % of a polyethersulfone or a polyetherimide, preferably a polyetherimide.

Embodiment 13: A cured composition comprising the product obtained by curing the composition of any one or more of Embodiments 1 to 12.

Embodiment 14: The cured composition of Embodiment 13, having a fracture toughness of 150 J/m² or greater as measured as per ASTM D5045.

Embodiment 15: An article comprising the cured composition of any of Embodiments 13 to 14.

Embodiment 16: The article of Embodiment 15, wherein the article is a coating, encapsulant, adhesive, or matrix polymer for composites.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

The singular forms “a,” “an,” and “the” include plural referents unless the context clearly dictates otherwise. “Or” means “and/or” unless clearly indicated otherwise by context.

The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group.

“Optional” or “optionally” means that the subsequently described event or circumstance may or may not occur, and that the description includes instances where the event occurs and instances where it does not. Unless defined otherwise, technical and scientific terms used herein have the same meaning as is commonly understood by one of skill in the art to which this disclosure belongs. A “combination” is inclusive of blends, mixtures, alloys, reaction products, and the like.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “alkylidene” refers to a straight or branched chain, saturated divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicyclic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents or variables are permissible provided that the substitutions do not significantly adversely affect synthesis or use of the compound. Exemplary groups that can be present on a “substituted” position include, but are not limited to, cyano; hydroxyl; nitro; azido; alkanoyl (such as a C₂₋₆ alkanoyl group such as acyl); carboxamido; C₁₋₆ or C₁₋₃ alkyl, cycloalkyl, alkenyl, and alkynyl (including groups having at least one unsaturated linkages and from 2 to 8, or 2 to 6 carbon atoms); C₁₋₆ or C₁₋₃ alkoxys; C₆₋₁₀ aryloxy such as phenoxy; C₁₋₆ alkylthio; C₁₋₆ or C₁₋₃ alkylsulfinyl; C₁₋₆ or C₁₋₃ alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇₋₁₉ arylalkyl having 1 to 3 separate or fused rings and from 6 to 18 ring carbon atoms; or arylalkoxy having 1 to 3 separate or fused rings and from 6 to 18 ring carbon atoms, with benzyloxy being an exemplary arylalkoxy. As is typical in the art, a line extending from a structure signifies a terminating methyl group —CH₃.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A high heat epoxy composition comprising:
a thermoplastic polymer;
an epoxy hardener; and
a high heat epoxy compound of formula: 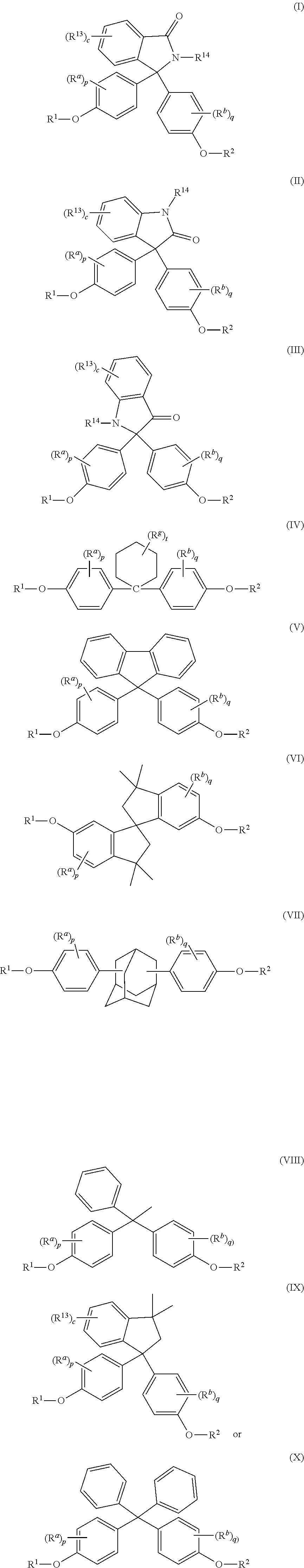
wherein
R¹ and R² at each occurrence are each independently an epoxide-containing functional group;
R^{a} and R^{b} at each occurrence are each independently halogen, C₁-C₁₂ alkyl, C₂-C₁₂ alkenyl, C₃-C₈ cycloalkyl, or C₁-C₁₂ alkoxy;
p and q at each occurrence are each independently 0 to 4;
R¹³ at each occurrence is independently a halogen or a C₁-C₆ alkyl group;
c at each occurrence is independently 0 to 4;
R¹⁴ at each occurrence is independently a C₁-C₆ alkyl, phenyl, or phenyl substituted with up to five halogens or C₁-C₆ alkyl groups;
R^{g} at each occurrence is independently C₁-C₁₂ alkyl or halogen, or two R^{g} groups together with the carbon atoms to which they are attached form a four-, five, or six-membered cycloalkyl group; and
t is 0 to 10; and
wherein a cured sample of the high heat epoxy composition has a glass transition temperature of greater than or equal to 200° C. measured as per ASTM D3418.

2. The composition of claim 1, wherein the cured sample of the high heat epoxy composition has a glass transition temperature of 200° C. to 270° C., as measured as per ASTM D3418.

3. The composition of claim 1, wherein the cured sample of the high heat epoxy composition has a fracture toughness of greater than 150 J/m², measured as per ASTM D5045.

4. The composition of claim 1, wherein the cured sample of the high heat epoxy composition has a fracture toughness that is at least 10% greater than a fracture toughness of a cured sample of a comparable high heat epoxy composition without the thermoplastic polymer, wherein the fracture toughness is measured as per ASTM D5045.

5. The composition of claim 1, wherein the thermoplastic polymer is selected from a polyetherimide, amine terminate polyetherimide, polyethersulfone, polyphenylene sulfone, polysulfone, polyarylsulfone, polyaryl ether, polyphenylene ether, polyetheretherketone, polyetherketone, polyetherketoneketone, polyketone sulfide, polyaryletherketone, aromatic polyamide, polyamideimide, polysiloxane, polyimide siloxane, polyimide, or a combination thereof.

6. The composition of claim 1, wherein the composition comprises greater than 0 to 25 wt % of the thermoplastic polymer.

7. The composition of claim 1, wherein the epoxy hardener is an aromatic diamine compound.

8. The composition of claim 1, wherein R¹ and R² at each occurrence are each independently: 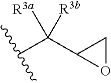
wherein R^{3a} and R^{3b} are each independently hydrogen or C₁-C₁₂ alkyl.

9. The composition of claim 1, wherein the high heat epoxy compound has the formula (1-a), (2-a), or (4-b),

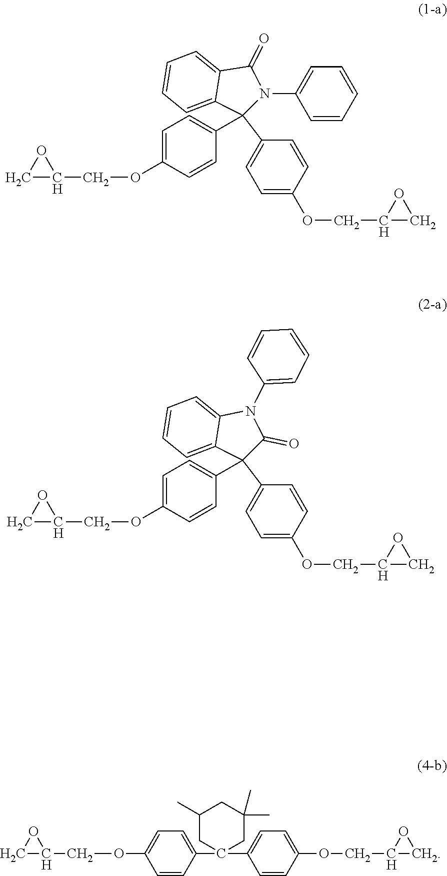 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

10. The composition of claim 1, wherein 10 to 40 wt % of a solvent is used to prepare the high heat epoxy composition.

11. The composition of claim 10, wherein the solvent is selected from dioxane, methylene chloride, chloroform, or a combination thereof.

12. The composition of claim 1, comprising 50 to 95 wt %, of a high heat epoxy compound having formula (1-a) 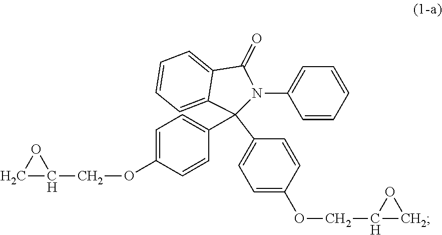 [SMILES: O=C1c2ccccc2C(c2ccc(OCC3CO3)cc2)(c2ccc(OCC3CO3)cc2)N1c1ccccc1]
and 1 to 20 wt % of a polyethersulfone or a polyetherimide.

13. A cured composition comprising a product obtained by curing the composition of claim 1.

14. The cured composition of claim 13, wherein the cured composition has a fracture toughness of 150 J/m² or greater, as measured per ASTM D5045.

15. An article comprising the cured composition of claim 13.

16. The article of claim 15, wherein the article is a coating, encapsulant, adhesive, or matrix polymer for composites.

17. The composition of claim 7, wherein the aromatic diamine compound is selected from 4-aminophenyl sulfone, 3-aminophenyl sulfone, 4,4′-methylenedianiline, 4,4′-methylenebis(2,6-diethylaniline), m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine, p-xylylenediamine, or a combination thereof.

18. The composition of claim 1, wherein the composition does not comprise a solvent.

19. The composition of claim 1, comprising 50 to 95 wt % of a high heat epoxy compound having formula (1-a) 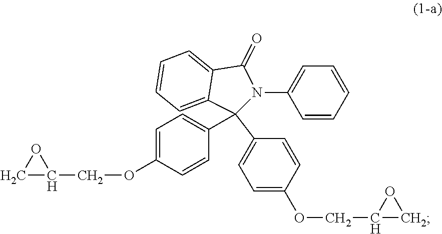 [SMILES: O=C1c2ccccc2C(c2ccc(OCC3CO3)cc2)(c2ccc(OCC3CO3)cc2)N1c1ccccc1]
and 1 to 20 wt % of a polyetherimide.

20. The composition of claim 1, comprising 3 to 15 wt % of the thermoplastic polymer selected from a polyethersulfone, a polyetherimide, or a combination thereof;
15 to 25 wt % of the epoxy hardener; and
65 to 85 wt % of the high heat epoxy compound of formula (I), (II), or (IV),
wherein the cured sample of the high heat epoxy composition has
a glass transition temperature of greater than or equal to 240° C., as measured per ASTM D3418, and
a fracture toughness of greater than 170 J/m², as measured per ASTM D5045.
